(19) United States
(12) Patent Application Publication
(10) Pub. No.: US 2016/0016305 A1
(43) Pub. Date: Jan. 21, 2016

(54) FLIP-FLOP TOOLBOX

(71) Applicant: CHIH-MIN CHANG, CHANGHUA COUNTY (TW)

(72) Inventor: CHIH-MIN CHANG, CHANGHUA COUNTY (TW)

(21) Appl. No.: 14/331,970

(22) Filed: Jul. 15, 2014

(51) Int. Cl. B25H 3/02; B65D 43/16; B65D 43/22; B65D 25/28

(52) U.S. Cl. CPC B25H 3/02; B65D 25/28; B65D 43/16; B65D 43/22

(57) ABSTRACT

A flip-flop toolbox includes a first bar including a first box member, a second box member, and a hinge including a first pivot axle perpendicularly and fixedly connected with one end thereof to one side of the first box member, an axle holder pivotally connected to an opposite end of the first pivot axle and two second pivot axles pivotally mounted in two opposite sides of the axle holder and fixedly connected to one side of the second box member in a perpendicular relationship relative to the extending direction of the first pivot axle. Thus, the second box member can be turned about the second pivot axles relative to the first box member to an extended position, and then turned with the axle holder about the first pivot axle through 180° relative to the first box member and then closely attached to the first box member.

### BACKGROUND OF THE INVENTION

1. Field of the Invention The present invention relates to toolbox technology, and more particularly to a flip-flop toolbox that can be inverted.

2. Description of the Related Art

A toolbox is a storage device for storing tools (such as spanners, screwdrivers or hammers) and accessories (such as screws, nuts or nails). Thus, a user can carry the toolbox with the storage items to the job site for application. A toolbox generally comprises a box body and a cover pivotally connected together, and at least one fastener for locking the box body and the cover in the close position. When wishing to open the toolbox, the user needs to unlock the fastener at first, and then extend out the toolbox and place it on the floor or tabletop for access to the storage tools and accessories.

According to conventional designs, even if the user simply wants to use one small accessory, the user needs to unlock the fastener and then open the cover from the box body so that the user can access to the storage items. This series of operating actions is not very convenient for the user. Further, after the user extended out the toolbox, the toolbox occupies about twice the space than the closed condition. If the toolbox is used in a narrow space, it can cause confusion on the surrounding environment. An improvement in this regard is desired.

### SUMMARY OF THE INVENTION

The present invention has been accomplished under the circumstances in view. It is the main object of the present invention to provide a flip-flop toolbox, which saves space and increase ease of use.

To achieve this and other objects of the present invention, a flip-flop toolbox in accordance with the present invention comprises a first box member, a second box member, and a hinge. The first box member comprises a first front wall, and a first rear wall opposite to the first front wall. The second box member comprises a second front wall, a second rear wall opposite to the second front wall, and a mounting groove located in the second rear wall. The hinge comprises a first pivot axle, an axle holder, and a second pivot axle. The first pivot axle has one end thereof perpendicularly and fixedly connected to the first rear wall of the second box member. The axle holder is mounted in the mounting groove of the first box member and pivotally connected to an opposite end of the first pivot axle. The second pivot axle is pivotally mounted in the axle holder and fixedly connected to the second box member. The second pivot axle extends in a perpendicular relationship relative to the extending direction of the first pivot axle. Thus, the second box member can be turned about the second pivot axle to an extended position. When extended out, the second box member can be turned with the axle holder about the first pivot axle relative to the first box member through 180°, and then turned about the second pivot axle toward the first box member to a received position, thereby saving the space and increasing ease of use.

Preferably, the first box member further comprises at least one female fastener located at the first front wall; the second box member further comprises at least one male fastener located at the second front wall and releasably locked to the at least one female fastener to lock the first box member and the second box member in the received position. Further, a ring lock can be attached to the female fastener to enhance the anti-theft effect.

Preferably, the first box member comprises a first accommodation chamber; the second box member comprises a second accommodation chamber, and a movable cover plate pivotally connected to the second front wall and movable relative to the second front wall between a close position to close the second accommodation chamber and an open position to open the second accommodation chamber. Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a flip-flop toolbox in a first received position in accordance with the present invention.

FIG. 2 illustrates the flip-flop toolbox in an extended position in accordance with the present invention.

FIG. 3 is a schematic applied view of the present invention, illustrating the second box member rotated through 180°.

FIG. 4 is an oblique top elevational view of the present invention, illustrating the flip-flop toolbox arranged in the second received position.

FIG. 5 is a sectional view of a part of the present invention, illustrating the female fastener fastened to the second retaining end of the mating male fastener.

FIG. 6 is similar to FIG. 4, illustrating the movable cover plate opened.

FIG. 7 is similar to FIG. 1, illustrating two ring locks mounted in the female fasteners.

### DETAILED DESCRIPTION OF THE INVENTION

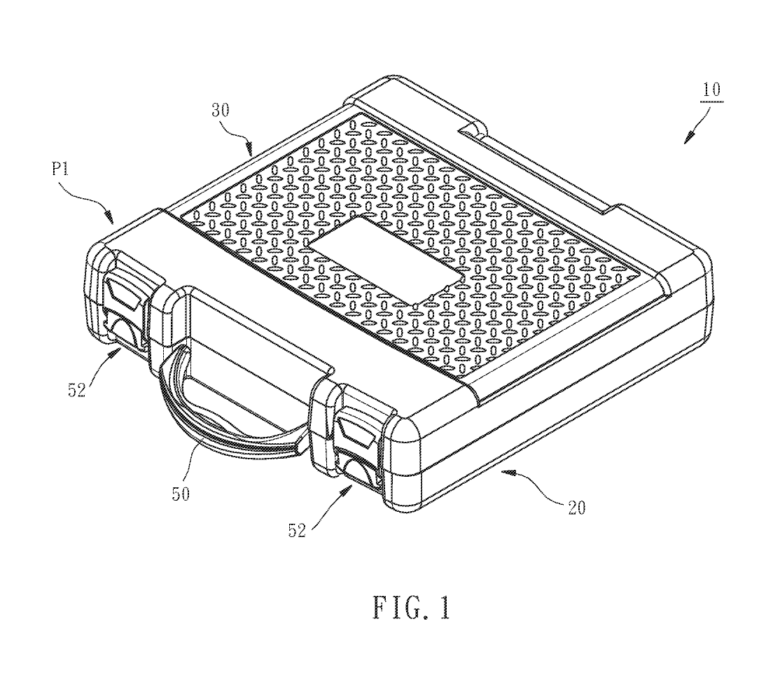

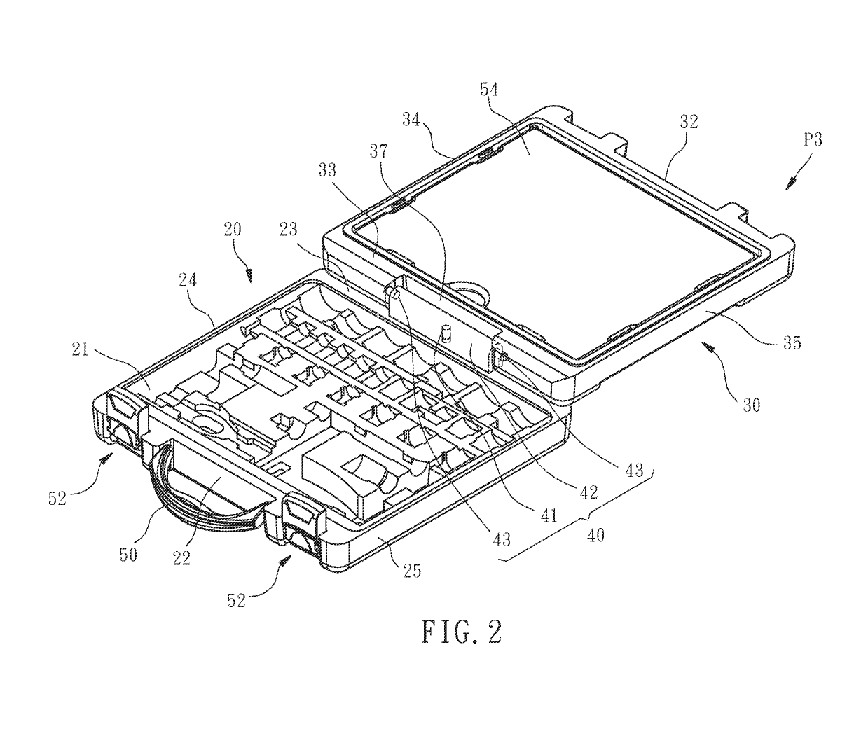

Referring to FIGS. 1 and 2, a flip-flop toolbox 10 in accordance with the present invention is shown. As illustrated, the flip-flop toolbox 10 comprises a first box member 2, a second box member 30, and a hinge 40.

The first box member 20 comprises a first accommodation chamber 21 adapted for accommodating tools (spanners, screwdrivers, hammers, etc.) or accessories (screws, nuts, nails, etc.), a first front wall 22, a first rear wall 23, a first left wall 24 and a first right wall 25 surrounding the first accommodation chamber 21, a carrying handle 50 located at the first front wall 22, and two female fasteners 52 located at the first front wall 22 at opposing left and right sides relative to the carrying handle 50.

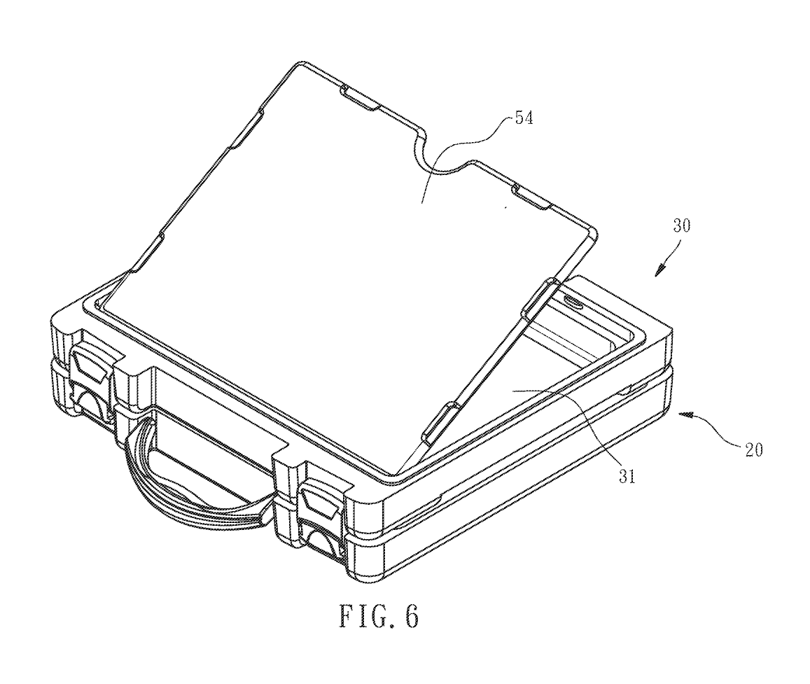

The second box member 30 comprises a second accommodation chamber 31 (see FIG. 6) adapted for accommodating tools (spanners, screwdrivers, hammers, etc.)

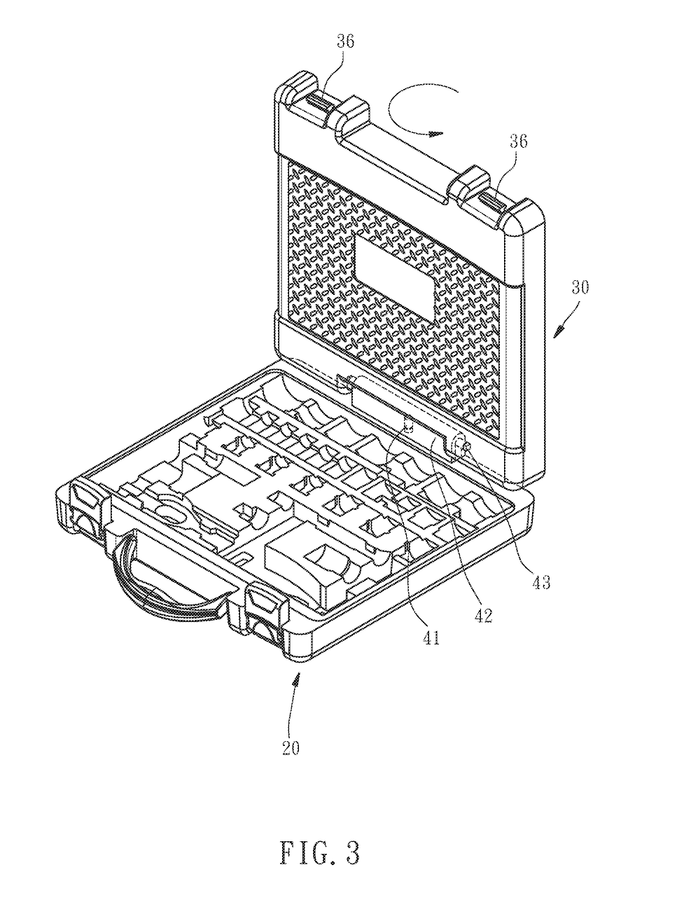

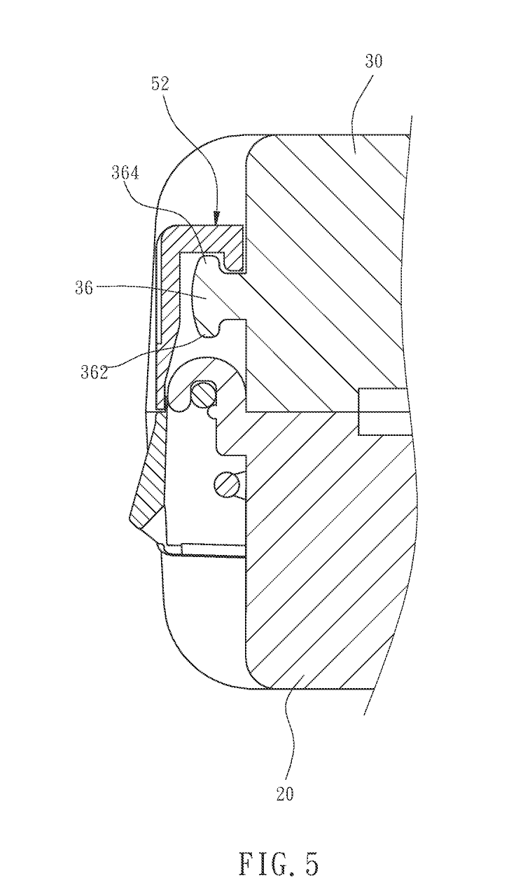

or accessories (screws, nuts, nails, etc.), a second front wall 32, a second rear wall 33, a second left wall 34 and a second right wall 35 surrounding the second accommodation chamber 31, two male fasteners 36 located at the second front wall 32 corresponding to the female fasteners 52, and a mounting groove 37 located in the second rear wall 33. Each male fastener 36 comprises a first retaining end 362 and a second retaining end 364 (see FIG. 3 and FIG. 5). Further, in order to prohibit tools or accessories from falling out of the second accommodation chamber 31, the second box member 30 further comprises a movable cover plate 54 pivotally connected to the second front wall 32 and movable between a close position to close the second accommodation chamber 31 and an open position to open the second accommodation chamber 31, as shown in FIG. 2 and FIG. 6.

The hinge 40 comprises a first pivot axle 41, an axle holder 42, and two second pivot axles 43. The first pivot axle 41 has one end thereof perpendicularly inserted into the first rear wall 23 of the first box member 20 and affixed thereto. The axle holder 42 is mounted in the mounting groove 37 of the second box member 30 and pivotally coupled with one side thereof to an opposite end of the first pivot axle 41 so that the axle holder 42 is turnable about the first pivot axel 41 relative to the first box member 20. The second pivot axles 43 have respective one ends thereof respectively pivotally connected to two opposite ends of the axle holder 42, and respective opposite ends thereof respectively and fixedly mounted in the second rear wall 33 of the second box member 30 at two opposite lateral sides of the mounting groove 37. After installation, the second pivot axles 43 extend perpendicular to the extending direction of the first pivot axle 41 so that the second box member 30 can be turned about the second pivot axles 43 relative to the first box member 20 between a first received position P1 and an extended position P3, and can then be turned with the axle holder 42 relative to the first box member 30 through 360° after reached the first received position P1.

When going to open the flip-flop toolbox 10, place the first box member 20 on the floor or tabletop, and then disengage the female fasteners 52 from the first retaining ends 362 of the mating male fasteners 36 of the second box member 30, and then turn the second box member 30 about the second pivot axles 43 from the first received position P1 to the extended position P3 (see FIG. 2). At this time, the user can directly take tools or accessories from the first accommodation chamber 21 of the first box member 20, or open the movable cover plate 54 and then take tools or accessories from the second accommodation chamber 31.

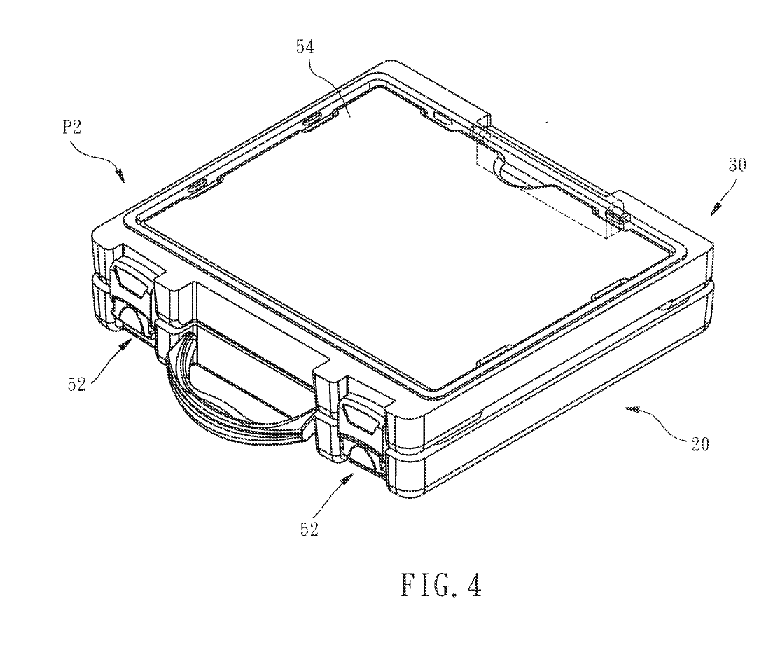

If the second box member 30 cannot be kept in the extended position P3 due to limitation of the job site space, the user can turn the second box member 30 with the axle holder 42 about the first pivot axle 41 relative to the first box member 20 through 180° (see FIG. 3), and then turn the second box member 30 about the second pivot axles 43 relative to the first box member 20 to a second received position P2 (see FIG. 4), and then fasten the female fasteners 52 to the second retaining ends 364 of the mating male fasteners 36 of the second box member 30 (see FIG. 5) to lock the first box member 20 and the second box member 30 in the second received position P2 to expose the movable cover plate 54 to the outside, as shown in FIG. 6. At this time, the user can open the movable cover plate 54 and then take tools or accessories out of the second accommodation chamber 31 of the second box member 30.

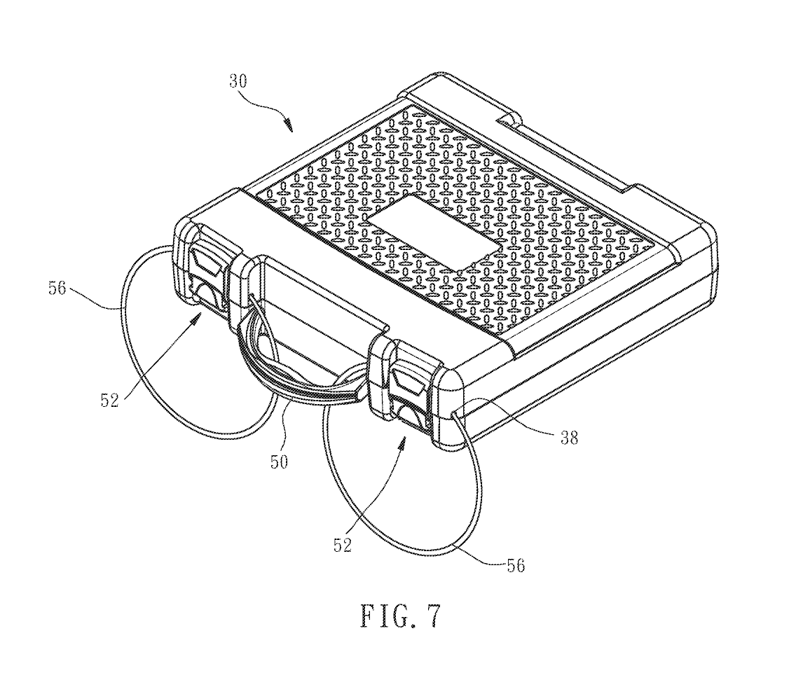

In conclusion, subject to the design and arrangement of the pivot axles 41 and 43, the user can rotate the second box member 30 of the flip-flop toolbox 10 through 180° and then lock it in position. At this time, the user can directly take tools or accessories out of the second box member 30 without unlocking the female fasteners 52 and opening the flip-flop toolbox 10, increasing ease of use. Further, either when the second box member 30 is set in the first received position P1 or the second received position P2, the flip-flop toolbox 10 simply occupies the space of one single toolbox. Thus, the flip-flop toolbox 10 can be used in a narrow space at the job site without causing confusion on the surrounding environment. Further, a ring lock 56 can be mounted in each female fastener 52. When the flip-flop toolbox 10 is not in use, each ring lock 56 is inserted through two lock holes 38 in the second box member 30 and the carrying handle 50 and locked, as shown in FIG. 7, preventing tools and accessories stored in the flip-flop toolbox 10 from being stolen by a theft and thus achieving the anti-theft effect.

Although particular embodiments of the invention has been described in detail for purposes of illustration, various modifications and enhancements may be made without departing from the spirit and scope of the invention. Accordingly, the invention is not to be limited except as by the appended claims.

What is claimed is:

1. A flip-flop toolbox, comprising;
a first box member comprising a first front wall and a first rear wall opposite to said first front wall;
a second box member comprising a second front wall, a second rear wall opposite to said second front wall, and a mounting groove located in said second rear wall; and
a hinge comprising a first pivot axle, an axle holder and at least one second pivot axle, said first pivot axle having one end thereof perpendicularly and fixedly fastened to said first rear wall of said first box member, said axle holder being mounted in said mounting groove of said second box member and pivotally connected to an opposite end of said first pivot axle, each said second pivot axle being pivotally mounted in said axle holder and fixedly connected with one end thereof to said second rear wall of said second box member, said second pivot axle extending in a perpendicular relationship relative to the extending direction of said first pivot axle.

2. The flip-flop toolbox as claimed in claim 1, wherein said first box member further comprises at least one female fastener located at said first front wall; said second box member further comprises at least one male fastener located at said second front wall and respectively releasably locked to said at least one female fastener.

3. The flip-flop toolbox as claimed in claim 2, wherein each said male fastener of said second box member comprises a first retaining end and a second retaining end; each said female fastener is selectively detachably connectable to one of the first retaining end and second retaining end of the mating said male fastener.

4. The flip-flop toolbox as claimed in claim 1, wherein said first box member comprises a first accommodation chamber; said second box member comprises a second accommodation chamber, and a movable cover plate pivotally connected to said second front wall and turnable relative to said second front wall between a close position to close said second accommodation chamber and an open position to open said second accommodation chamber.

5. The flip-flop toolbox as claimed in claim 1, wherein said first box member further comprises a carrying handle located at said first front wall.

6. The flip-flop toolbox as claimed in claim 5, wherein said second box member comprises at least one lock hole; the flip-flop toolbox further comprises a ring lock inserted through said at least one lock hole and said carrying handle of said second box member.
